(19) United States
(12) Patent Application Publication
(10) Pub. No.: US 2008/0179261 A1
(43) Pub. Date: Jul. 31, 2008

(54) Single disc dual flow rotary filter

(76) Inventor: Hubert Patrovsky, St. Eustache (CA)

Correspondence Address: HUBERT PATROVSKY, 580 BOUL INDUSTRIEL, ST EUSTACHE, QC, J7R-5V3, omitted

(21) Appl. No.: 11/699,842

(22) Filed: Jan. 31, 2007

(51) Int. Cl. B01D 29/09

(52) U.S. Cl. 210/767; 210/324; 210/359

(57) ABSTRACT

A filter with filter chambers disposed in an annular zone on a rotatable common disc has a multitude of separate flow passages, each flow passage containing within its flow stream at least one filter chamber on the common rotatable disc, and each identical flow passage is rotated around the axis of rotation of this common rotatable disc, thus multiplying the flow capacity of a rotatable disc filter by using the same disc to filter multiple streams. The rotatable common filter disc is disposed within a slot formed by body blocks and spacer blocks and rotates around a hub, the spacer blocks and hub controlling slot width such that rotatable metal to metal seals form between the disc and the body blocks in contact with a surface of the disc, forming leak free seals. The rotation of the rotatable common disc causes filter chambers, sealed within the slot, to change filter chambers as material accumulates within the filter chambers. An extension of the body block in contact with the rotatable disc on the surface without filter chambers provides further support, more temperature uniformity, and prevents fluid dripage. The filter improvement with multiple flow passages provides for higher flow through any specific rotatable filter disc size.

### BACKGROUND AND PRIOR ART

The asymmetric rotary filter or rotary disc filter has been on the market for several years. It was first marketed in Europe where a version of a disc filter is covered by European Patent EP o 114 651 B1 (filed in December 1983 by Rehau, AG) and there are two US Patents on the subject, one narrowly drawn to a filter chamber purging method issued as U.S. Pat. No. 4,588,402 to Gneuss and another as U.S. Pat. No. 4,710,288 issued to Hubert Patrovsky (Dec. 1, 1987). A number of asymmetric design rotary disc filters have been sold in the United States and Europe. The disc filter design has unique capabilities to provide a change in filter media with very low variation in the pressure drop across the filter unit. This is due to the shape of the filter chambers and the fact that the lands sealingly separating filter chambers progress through the flow path at a relatively constant amount of exposure so the flow going through the filter remains close to a constant.

The design of the shaped filter containing flow chamber is restrained by the land area between filter chambers which seals the chambers with metal to metal seals against ambient and other chambers and the balance of distorting forces which limits the total area of filter chambers in the flow path. These design constraints often result in selection of a kidney shaped filter chamber footprint (surface on disc) and a filter chamber shape that looks like a series of bent trapezoids.

Another restraint is the size of the filter chamber that will be filled by the material being filtered. The filter flow chamber must be pre-filled to prevent buildup of air within the sealed flow channels and to insure that flow is relatively constant. A large filter chamber area is a problem due to the amount of fluid required to fill the chamber. The land widths that provide seals between filter chambers also put a practical limit on the number of flow chambers. The practical limit on chambers may be under 20 per disc in many cases. Many materials that easily degrade or which are chemically aggressive may be filtered while keeping the considerable operational advantages of disc type filters and the superior metal to metal sealing methods possible with these filters.

The rotating disc filter also has a disadvantage in that it requires extreme machining accuracy to prevent leaks. Since surface area and the related problems of machining very flat surfaces increase exponentially with diameter, the size of discs is often governed by the present machining capabilities and disc diameter affects the area of filters that can be accessed in the flow stream and thus limits total flow within a filter.

The general design of the present filters is an asymmetric design which was needed to handle the general range of filtration requirements. The asymmetric layout provides a maximum access to the filter chambers which contain the filter media. In most applications where at least some times there may be high contamination levels, there must be access to many of the filter chambers since the disc containing the filter chambers may move a number of times in the short time that is required to change from a contaminated used filter media to a new clean filter media. In most cases the change is effected by the removal of multiple stacked contaminated screens shapes that fit into the filter chamber using a sharp object, the scraping of the top of the filter chamber, and the replacement of the dirty screens with clean ones. The standard asymmetric screen changer has more than 50% of the disc containing filter chambers exposed to accommodate the changing of screens.

The other feature of the asymmetric rotary disc filter is the access to both sides of the filter chamber containing disc. This general access allows the filter media supports to also be accessed. In some cases the machined holes on this support may also be cleaned or the disc cools enough that the polymer solidifies and pops out of the holes in the filter support when the screen is removed. In other recently developed applications, removable filter supports are used and the filters and the filter supports can be removed, cleaned and replaced together. In general, one of the key features of the rotary disc filter was the general access to the filter disc. This access was a major design consideration despite the extra space that an asymmetric design required.

The requirement for large areas of exposed disc does create problems. The use of higher temperature polymers and more crystalline polymers in particular creates problems because of the high heat loss due to the exposed disc and the possibility that solid particles of cooled polymer enters the flow stream as new filter chambers enter the filtration area causing process upsets. There is a need for better temperature control over filtration.

In other applications polymers drip, they may be hazardous or have hazardous components, or they may be sensitive to air drying or air reacting with the polymer or fluid. In these special cases the asymmetric design fails since it has so much exposed disc area. There is a need for a disc type filter that reduces the disc exposure tp ambient.

There are other special cases where filters are used to handle solvent containing polymers where dripage becomes a major problem with the asymmetric filter. This filter which was designed for maximum access to the filter disc becomes a severe liability since the highly fluid solvent containing stream flows from the filter and through the filter support holes causing solvent and polymer accumulation outside the filter. There is a need for a filter that handles the solvent containing materials without problems and with minimal dripage.

The advances in extrusion and downstream forming technology requires ever more uniform and purer plastic melts. This often requires the addition of further equipment to provide the pressure or flow uniformity needed in today's applications where thin part walls and thin films are increasingly common. As devices are added to existing lines, there is a major space problem There is no compact filter that can handle high volume flows with essentially no pressure variation as the filter media is changed.

The need for uniformity includes both chemical/solvent consistency and also thermal consistency. The asymmetric filter has a large area of the filter media containing disc exposed to ambient temperatures so that it cools far below the melting temperatures of most polymers. There is a need for a lesser exposure to cooling which is also solved by the double or multiple contact areas of this invention.

It is further obvious that if space was not the important consideration that it is, a series of separate filters arrayed in parallel could provide the needed protection to an extrusion line. In fact, with unlimited space, rows of filters arrayed in series for each filter screen size and in parallel for total flow in a processing line would be possible. This conceptual layout ignores a factor of great importance in dealing with several separate sequential screen changers, the fact that there is cumulative reliability determining the downtime potential of the process. This cumulative reliability curve provides that if each element in a series of units has a known reliability, the reliability of a system composed of these units is the product of their reliability. In most cases that would indicate that added complexity would seriously lower time between failures. There is a need for use of process elements in common to reduce the cumulative reliability liability. There is no compact unit in today's marketplace that can provide the function of several filters without lowering the system reliability.

### DESCRIPTION OF THE INVENTION

This invention provides a single filtration unit for the special cases of fluids with light to moderate contamination levels and where access to the filter changers is not hazardous. The new filter concept accommodates multiple flow paths and the resulting higher flow rates through a single disc. The filter thus takes up little more space than conventional asymmetric rotary filter units yet offers two filtration flows within little more housing and space constraints than the known single flow asymmetric filter with the added advantage of more balanced forces, uniform temperature conditions, greatly reduced dripage, and a disc axis central to the flow path.

The invention, by using a disc and a number of highly machined elements in common, and by reducing the size of the elements needed for a given flow, provides for improved costs for this filter concept which is capable of handling two flow streams within a single filter housing and which, by simplification of filter shapes cuts machining.

The invention further allows close control over temperatures of the filter unit within the metal body blocks that is lacking in large filters and in asymmetric filters which can render very large disc filters inoperable. The use of two or more flow channels also reduces the exposed area of the disc and makes the temperature profile of the disc closer to the ideal condition of no temperature variation in the flow area of the filter. Also it decreases thermal degradation and thermal freezeoff problems.

The invention is based upon the use of a single filter housing that accommodates a single rotary disc that has two parallel flows passing through filter chambers within opposite sides of the filter disc. The total flow of material to be filtered is input into an infeed adaptor where the total flow is split into two separate flows, each within its own channel. The separated flows then enter an infeed block where each separate flow is modified in an infeed block from an input shape (typically round) into a footprint shape designed to accommodate expanded flow area prior to the filter media. The individual flows pass from the infeed block to a rotary and rotatable disc which has filter chambers, each filter chamber with filter media and filter support. Each separate flow passes into one or more filter chambers and then through the filter media and the filter support in each of the shaped filter chambers which are located in an annular region of the externally driven rotary disc and which are supported by filter supports. After passing through at least one of the individual filter chambers mounted within the disc, the filter media, and the filter support in each individual flow path, the flow stream still configured in the footprint shape passes into an outflow block from the rotary disc where it is restored to an outfeed shape (which is typically round) in an outfeed block and then each flow stream goes to adaptors that combine the two individual flows back into a total flow stream and the combined filtered flow is directed to further processing equipment. The two separate flow streams are thus each directed to a separate set of filter elements within a common rotary disc. Typically, the flow channels and the disc elements are dualled and geometrically similar in shape, being geometrically rotated into position around the common central axis of the rotary disc such that the two flow channels are in positions 180 degrees opposed and within the annular area traced by the footprint of each flow stream on the common rotary filter disc.

The rotary disc used in the invention has a common hub arrayed concentric to the center of rotation of the common rotary disc of the dual flow filter. The disc has a plurality of machined chambers located in the annular region traced by the footprint shapes as the disc rotates that hold removable filter supports or have filter supports permanently machined into the disc. Shapes and size of the filter chambers are known in the industry and are constrained by metal distortion, contained volume and flow uniformity considerations. Filter media such as screens are added to the supports within a clearance area of filter chamber area and held within this machined chamber on the inflow or infeed side of the filter supports. Fluid flow is through separate channels, and each separate flow passes through the filter media on a separate area of a common rotary disc containing filter chambers. After the two flow streams are filtered, the multiple streams are delivered by an exit body flow channel which transforms the shape of the channel from the footprint shape to a flow channel shape, typically round, and then to an exit adaptor where the two separate flows are merged into a common flow and the common flow is directed to separate processing portions of the process line. Typically these will be various forming dies or other processing machines located after the filter.

Each of the two flows through the common disc acts as an independent filter, thus the functional equivalent of two filters is contained within nearly the same housing depth and size that formerly handled only a single flow through a single rotary filtration disc. Despite provision of two the capacity of two individual filters, the flow capability of each of the two or more individual filters with their separate flow streams is nearly the same as for the prior art single disc asymmetric filter containing only one flow stream.

Looking at specific problems now evident with the disc type filter and how the present invention solves these problems, the general inhibiting factors concerning discs will be examined, then the temperature problems of rotary filters, the pressure problems, manufacturability, the use on normal and specialty polymers, and the extended screen areas possible are examined.

The size of the filter in this invention is greatly reduced as compared to the asymmetric filters of similar output previously made to accommodate rotary filtration. In a typical filter with a 100 mm size (the size represents the size of the inflow channel diameter in mm), the actual size of the rotary disc is approximately 500 cm in diameter. In this example, the total width of an asymmetric standard filter unit with disc and housing which handles a single flow is actually 567 cm. With the present invention, using the same 500 cm disc, two flows can be filtered, with basically twice the total flow, within a total width of 633 cm for the filter. In addition, the asymmetric filter hangs toward the disc side (the remote hub) such that on the side that the operator uses to change filters, the filter projects approximately 250 cm further into the operator space than the present invention despite the lowered flow of this asymmetric filter. It is further noteworthy that the asymmetric filter must be made in two versions so that operator access can be from either side.

The space saving feature of this invention is very significant in the replacement of existing plastic processing equipment, and the operator has access to the filter from either side which provides considerable installation flexibility and eliminates need for a left and % right hand model since the axis of rotation is centered upon the process line fluid flow channel.

The disc in a rotary disc filter unit has been a constant problem in manufacture. Numerous manufacturing breakthroughs were needed to reach a reliability factor that made use of discs practical. First, the tolerances needed were close to the limits of machining technology. Then the surface hardness and chemistry which inhibits galling and seizing of the metal to metal surfaces where they are in rotatable contact at elevated temperatures was also critical. Finally the torque requirements in many filters required complex adjustment for internal operation pressure and for operation temperature. Since all of the above factors are also functions of size, with the problems becoming exponentially worse as disc diameter was increased (i.e. it is a function of disc and sealing surface areas), there were a major pricing, practicality and cost problem as higher flow requirements forced larger and larger discs to be used so greater flow areas and thus greater flows could be handled. Despite the cost and machining problems, no one realized that a dual flow was practical until the present invention due to the problem of access and driping of molten polymers.

The asymmetric filter design in present use was designed to provide close to the optimum in internal flow channel area (and the resulting flow internal pressures). As a result, the concept of doubled or multiplied flows within a given size filter was ignored since expectation was that the internal forces would be such that metal to metal sealing techniques successful in the asymmetric filter would fail at forces in excess of those on the single flow footprint. In fact, when the extra bolts allowable due to the symmetrical shape of the side blocks are considered and the counteracting forces of the deflected block relieving part of the force of each channel is considered, it turns out that the doubling of the flow channel and footprint is feasible.

Despite the advances in the manufacturing process, seal surfaces still fail unexpectedly. Part of these failures are attributed to the unbalanced seal surface forces. It is important to seal integrity that forces are balanced. At present in the asymmetric filter the force balance is unsatisfactory.

The dual flow single disc filter has vastly better force balance. The static force balance is essentially a mirror image around the central axis of the filter such that the bolt patterns are identical from one side of the filter to the other side. The forces are very similar but not totally identical since the footprint shapes are rotated around the central axis rather than a mirror image. The differences in forces due to the footprint shape however are negligible as compared to the non-balanced forces present in the asymmetric filter design.

A single disc filter within the standard asymmetric design normal in rotary filters had the greater portion of the disc outside the housing of the sealing area. These projecting areas cool. The cooling affects flow by requiring added heat input to the body of the filter to compensate for the cold disc portions entering the filter body areas. The cooled resin trapped in the holes of the filter support, if not properly reheated, can cause major problems with the parts being produced from the polymer. These temperature variations cause problems that can result in minor surface imperfections, and/or major thickness variations up to the tearoff of a continuous web which results in line shutdown. The variations must be minimized or eliminated.

The dual flow single disc configuration using a common filter containing disc, when examined, shows a balanced heat requirement across the die body unlike the typical single disc asymmetric filter design where heating on only one side of the rotating disc can cause overheat in adjacent areas. While the flows are separate, the uniformity of heat required in the blocks that partly enclose the rotary filter discs is more uniform in the dual flow single disc filter design. There is less disc exposed and the disc as it enters the filter flow areas is encased within large blocks that are easily heated. There is no need for shock heating which often results in overheat conditions.

In a normal asymmetric filter design the only way flow can be increased is to go to a larger disc. A larger disc and housing allows more filter area in the flow stream and thus can handle larger flow. The thermal problems caused by such a large disc are also major. Heat loss and the requirement for reheating of the disc area that was exposed as the filters are changed requires localized overheating of the body blocks which can cause scorching or degradation of the resins and can adversely affect the flows of the resins. Going to a geometrically balanced shape lowers the heating non-uniformities within the filter and allows better temperature control which shows as better processed parts. Lowering the total exposed disc area also lowers the amount of the disc cooling.

The heating problems were minimal when filters were used on the easy to process plastics such as low density polyethylene, polystyrenes and similar broad melting point thermally stable resins. The heat concentrations become much more important when there is a easily degradable polymer or one of the polymers becoming increasingly popular with very high processing temperatures and a high degree of crystallinity which freeze in a narrow temperature band.

Polymers with a very narrow thermal transition temperature, (i.e. one where the polymer solidifies over 5 to 40 degree F. temperature range) are especially hard to handle since if the freeze up temperature is approached, the solidification can cause major process disruption. The balanced design of the dual flow unit helps prevent these freeze up problems since there is less disc exposure to ambient and the bulk of the heated blocks quickly warm up the relatively small exposed disc area as it reenters the filter housing.

In degradable polymers the degradation mechanism is based on both time and internal temperature of the filter. The time that the wall hugging lamella of flow takes in traversing a given process element and the temperature at that wall combine to cause degradation. Time is determined by flow channel dimensions and the total throughput of the process. Temperature is a variable factor and over temperature can cause serious process problems. As a result, an elimination of cool spots in a process greatly lowers the need for high heat conditions and lowers possibility that degradation will occur. The balance of the cooler disc portions entering on both the bottom and the top of the separator block as shown in FIG. 2 allows even heating and less overheating as compared to an asymmetric single disc filter where the load is unbalanced as shown in FIG. 1. A balanced load allows a change from small localized heaters producing hot spots to large plate heaters applied to the exterior of the filter body blocks giving much better heat transfer and avoiding localized hot spots and cool spots.

A single disc asymmetric filter also has unbalanced pressures. As seen in FIG. 1, the distribution of the bolts through the body blocks and the spacers are in an asymmetric array. These asymmetricaly arrayed bolts create unbalanced forces require skilled installation and special techniques to insure that the rotary disc moves freely within the body blocks at all temperatures and internal pressures while providing a leak free metal to metal seal. The use of torque to insure a uniform high compressive clamping force on the filter is much less reliable when the loading is asymmetric. Better torque uniformity adds to seal reliability. If the seal leaks, the rotary is not acting as an effective filter.

In contrast, the pressure distribution of the filter shown in FIG. 2 shows a symmetric balanced distribution of bolts around a central axis and that, with the dual use of many of the bolts, provides an easier to adjust leak free rotating disc. The balanced design helps provide more uniformly balanced forces. The balanced design also allows use of a larger flow footprint within the body blocks and thus more screen area in contact with the fluid being filtered. The larger area also allows higher throughput at a given pressure drop or lower pressure operation at the same throughput.

Manufacture of a rotary disc filter that has leak free seals that operate independently of temperature and internal pressure of the fluid being filtered requires the strict observance of a series of painfully derived rules. These rules regard the flatness, the bolt placements, the uniformity of the steels, the metallurgy and the heat treating/coatings used. The basic rules must be followed, but if they are, at higher flow rates, the filter rapidly becomes too big to machine. The manufacture of filters under a 26 inch disc size fits a number of manufacturing processes and is effective.

A first consideration is the uniformity of the steel used. While there is a general assumption that in a given steel part the metal is uniform, when very high tolerances are required, this assumption is often wrong. When flatness of under 1 micron is needed, the slightest variation in composition will cause a slight variation in the grinding of the flat surface that can exceed the allowable tolerances. As multiple pieces are machined, probability of a flaw is increased. The reduction of total amount of steel and area of highly ground and coated precision surfaces per output unit greatly improves cost efficiency and lowers machining and production risk factors. Dual flow filters provide more throughput per inch of disc diameter than other rotary disc designs. This material efficiency breakthrough removes many of the problems with metal uniformity since the parts remain within the size range of available high quality homogenized tool steels and precision grinders and other equipment.

The metallurgy and treatment involved is also very important. The parts that form the sealing surfaces are hardened. Unfortunately, the hardening process stresses the steel and causes distortions. Areas of material inhomogeniety also harden differently and cause large local stresses that create disruptive distortions. These distortions become worse as parts increase in size and as clamping forces holding parts together are varied because the parts are shaped in asymmetric forms. The dual flow common disc filter with a symmetric shape lowers these problems. Some of the needed metal surface changes such as nitriding and coatings such as titanium nitride (TiN) also are problems due to part distortion. These coatings require elevated temperatures and may cause surface distortion of the steel, nonuniform layering or variable depth in compound formation. Such distortions and the normal warping of asymmetric parts results in flatness that is not acceptable so the parts require a finish grind that tends to remove much of the desired treatment or coating.

The filter in use on normal polymers can employ both the expanded area of footprint and the dual feed points of the symmetrical design. The term normal is used herein to describe those polymers which are typically run at process temperatures below 500 degrees F. and they are relatively stable, resisting sudden thermal degradation and do not chemically attack metals and which are further low in crystallinity or with wide transition temperature ranges. The polyolefins and the polystyrenes, are typical easy to use normal polymers. These polymers handle easily in both the symmetric and the asymmetric filters and the benefit of the symmetric unit is lowered cost and higher flow per unit of disc diameter.

An easily degradable material such as ethylene vinyl alcohol (EVAL) greatly benefits from the symmetrical filter arrangement. The improved heating of the blocks, the smaller flow passages which have less holdup, and the normal footprint of the filter allows higher flows and reduced degradation. Especially important with the degradable polymers is the lowered exposure of the rotatable disc and the resulting elimination of much of the overheating needed to reheat exposed parts of the rotary filter disc as it is brought back into the flow stream with fresh filter media.

In high temperature polymer processing, the symmetrical filter becomes a true star. The problems with temperature such as the reduced properties of many materials of construction and metal alloys as temperatures reach 700 to 825 degrees F. are magnified in the standard asymmetric design. A high volume high temperature filter becomes a massive part of the process line with present asymmetric designs. The symmetric design reduces the temperature problems and the total volume of metal heated. The symmetric design also allows better heater plate design on the body. These design improvements that are inherent in the symmetrical design also greatly aid processing of polymers that have low transition temperature ranges or are highly crystalline.

Some polymers are also very corrosive. The usual solution for high corrosivity is to use exotic alloys and coatings which are extremely expensive. The added flow of the dual disc symmetric filter allows use of less metal and thus makes filters of the exotic alloys more affordable as compared to two separate filters.

A further advantage of the symmetrical screen changer is that the balanced forces free the body blocks or body blocks from part of their anti-deflection role. The forces of polymer within the channels and the conical expansion of the input channels to the footprint shape are restricted by the need for rigidity and the need to restrain the tendency of the body blocks to deflect away from the rotary disc. When the forces are balanced, the need to reduce these bowing or distorting forces is greatly reduced since the central bolts through a central spacer block act in part as a fulcrum and the force of bowing on one side becomes a force inhibiting bowing on the other side. The net result is that the massive body blocks used to insure no bending could be somewhat reduced. The advantages of the central bolts through the body blocks and the spacer blocks is balanced forces and, while total force increases, the reduction of bowing or deflection is clearly shown when force balances are considered.

The effect of the symmetry and the resultant improved clamping force of the dual flow common disc filter is shown in the drawings. As shown in FIG. 4 where an overlay of a single asymmetric design disc spacer and disc is made on a dual disc of the same size, there is a greater area for the flow to contact the filter chambers in the disc. With a dual flow common disc symmetric design, there are externally directed forces, but these forces are directed to partly balance each other so that the outward force from one footprint pattern is reduced by the deflection caused by the compression due to the outward force of the other footprint.

### DESCRIPTION OF DRAWINGS

In FIG. 1 the present state of the art in asymmetric rotating disc filters is shown. The single disc 1 is sandwiched between a rear body block 2 and a front body block 3. The bolts holding the spacer block 4 are shown as 5. A hub is shown as 7 and this hub is held in place by further bolts 8. The polymer flow channel is shown as 9 while the footprint of the flow contacting the disc is 10. Filter chambers 11 are shown in the disc with a filter support in the insert 12.

In FIG. 2 the symmetric dual flow concept is shown in a simplified assembly drawing where an adaptor separates a single flow into two flows in separate channels, 38 as the first channel, and 39 the second channel, the first channel flowing through the body block channel through the symmetrical rear or input body block 22, flaring the flow channels out to footprint shapes 30 and then through the filter chambers 28 at the first channel contact footprint on the common disc 24 a further downstream or output body block 34 continues the flow channel footprint 31 and reduces the flow channel to a round shape in a output body block 33 and merges this first channel with the second channel in the adaptor 36. A second flow channel 39 has similar components. The common disc rotates around hubs 49 and spacer blocks 50 determine the width of the slot created by the two body blocks.

In FIG. 3 the assembly drawing of FIG. 2 is shown with the body blocks assembled around the common rotary discs and where bolts 47, 48 attach the body blocks, hubs and spacers to each other in a force balanced pattern.

FIG. 4 shows the flow passages along the axis of the flow channels from a top view.

FIG. 5 shows the space saving aspect of the dual flow in that the 5A asymmetric filter and 5B with the dual flow channel symmetric filter with little added width.

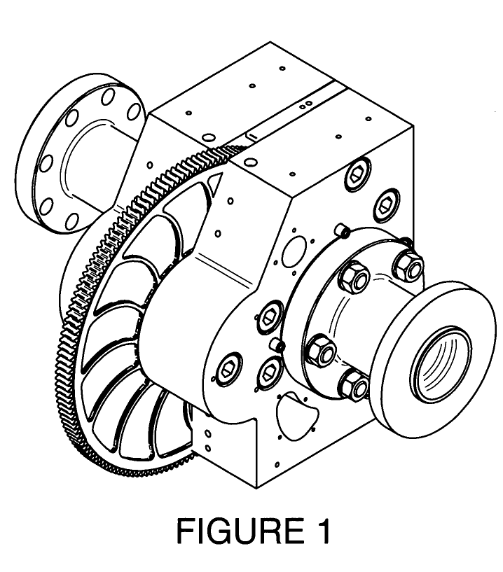

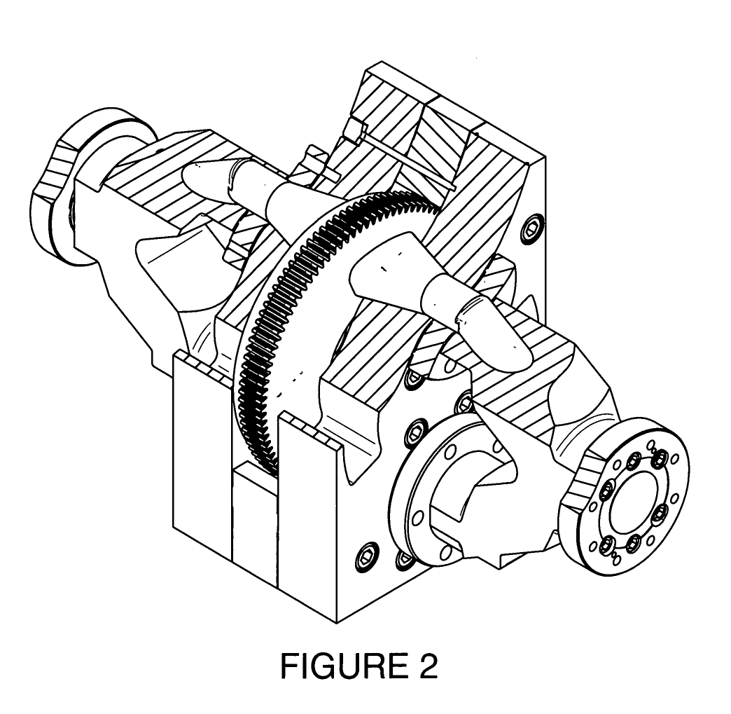

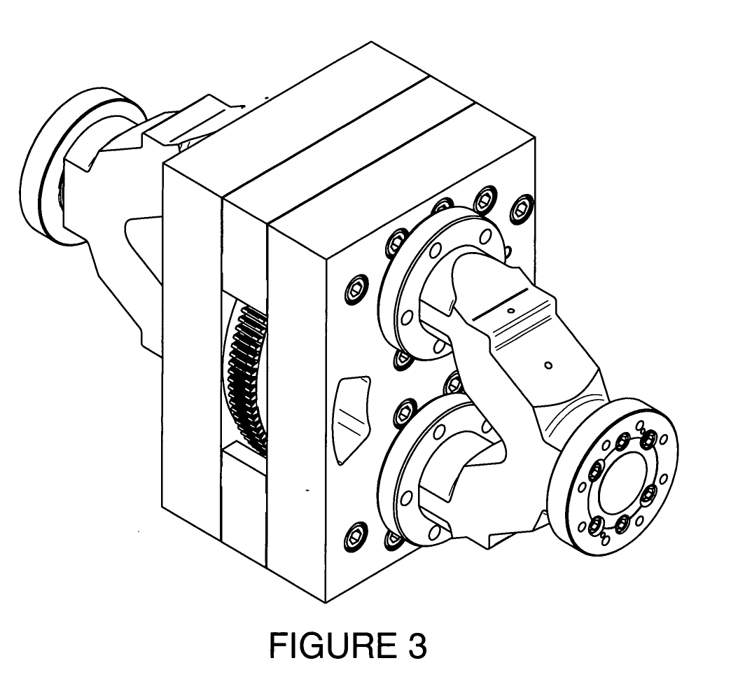

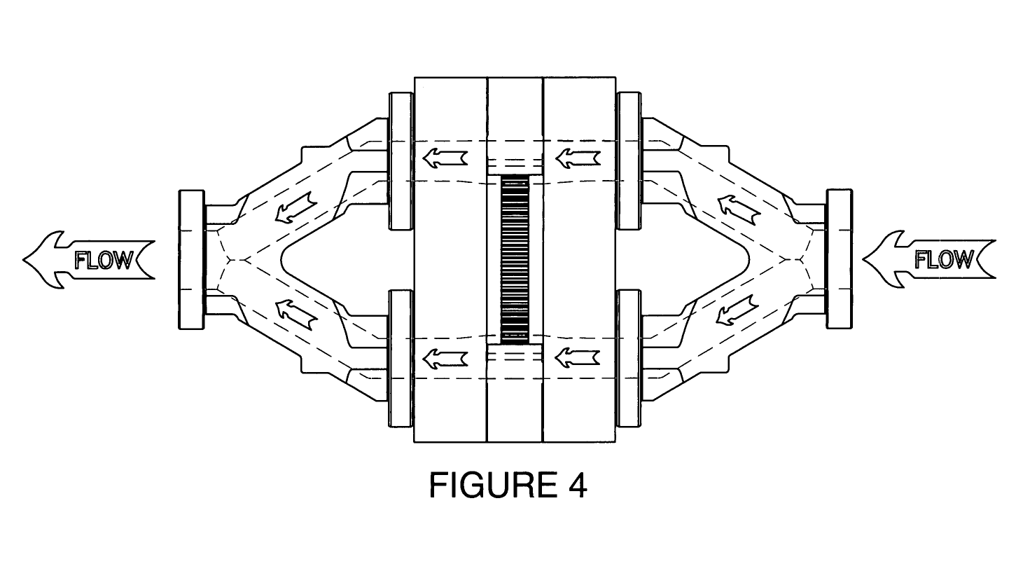

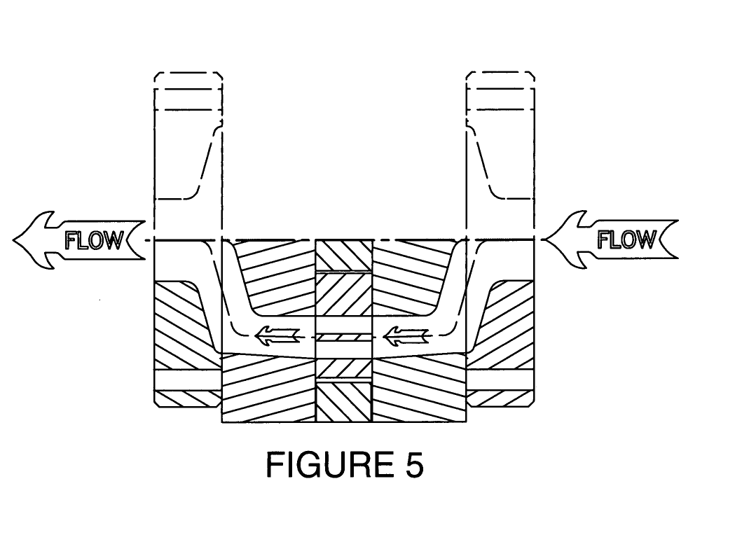

### PREFERRED EMBODIMENTS

In the preferred embodiment of the invention, a common disc dual flow fluid filter is manufactured with a flow stream entering an infeed adaptor where the flow stream is separated into dual parallel flows which exit from the infeed adaptor into the infeed side of an entry block of a rotary filter. In this infeed block each separate flow channel is shaped into an extended footprint shape which is extended in area as compared to the initial flow passage and shaped to accommodate filter chamber shapes machined into the rotary disc. The footprint shapes and flow channels for each flow stream are identical, being rotated approximately 180 degrees from each other. As each flow stream passes through its separate flow channel, it flares outward within the shaped flow channel to a footprint shape at the surface in contact with the rotary filter disc, the footprint shape selected to be compatible with the filter chamber shapes. The flow then enters a portion of a common rotary disc which holds filter chambers and filter media with at least one filter chamber in the flow path at all times and in many cases a multitude of filter chambers are in the flow path. The disc contains a series of filter chambers that are spaces to accommodate filter media with filter supports from the filter chambers that are on the infeed side of the rotary disc connected to the outflow side of the rotary disc by filter supports that hold the filter media and prevent it from bending. In most cases these filter supports are drilled holes in the rotary filter block but they may be removable inserts or reinforces screen or perforated plate. At the bottom or outflow surface of each filter chamber there are filter supports which in this preferred version consist of a number of drilled holes from the bottom of the filter chamber and below the filter media through to the side of the disc away from the filter chambers. The fluid flow is directed through the filter support holes in the common rotary disc as it exits from the filter chambers and filter supports, into an individual output channel in an exit block. In this exit block the surface in contact with the common rotary disc of each flow channel has a flow channel that is the shape of the footprint in the input block. Within this exit or output block, each individual exit footprint shape in each of the separate flow channels is reduced to the shape of an adaptor flow channel, which is typically round, by the output side of the output block of the filter. From this adaptor flow channel shape at the outlet end of the output block, the flow is directed to an output adaptor where the two separate flows are recombined and which directs the fluid from the recombined flows to further processing equipment.

FIG. 2 shows an assembly view of a dual flow passage filter unit with the separate dual flow streams in the input block 22 taking a single first input flow stream 22 from a first input adaptor 21. The adaptor is bolted to the input body block. This first flow 22 then enters first flow borehole 54 in the input body block which is typically round, and where within the input body block, the first flow path is expanded smoothly into the first footprint shape 30 (visible on mating shape as first output channel footprint 31 in output body block 34) which contacts the common rotary filter disc 24 which rotates around a central hub 49 which is approximately in line with the flow streams prior to their division into dual streams, and contains multiple filter chambers 28 within an annular zone 41 which are each separated from adjacent filter chambers by lands 56. Due to the expanded footprint shape, the footprint shape covers at least one full filter chamber and in many designs will cover several filter chambers. After passing through the filter chambers and the filter media within the filter chambers, which completes the filtration, the flow is through the filter support holes 51 in the filter support 29 to the output side of the common rotary disc 26. A channel output footprint 31 located on the disc side 35 of a output body block 34 is shaped as in the first footprint in the inlet body block and the footprint shaped borehole diverts flow and reshapes it from the footprint shape to an output channel shape 33, typically round, in the exit side of the output body block. The flow is directed into the adaptor flow shape and then through the output body block to a exit adaptor 36. The second flow stream from the input adaptor is identical in elements and design to the first flow stream but it is in a position that is rotated around the axis of rotation 40 of the common disc by 180 degrees to form a parallel filtration flow. In this rotationally identical flow stream, within the entry body block, the flow is expanded to the second footprint shape which contacts the second portion of the common rotary filter disc 24 which rotates around the common hub 49 and contains multiple filter chambers 28 separated by lands 56. Due to the expanded footprint shape, the footprint shape covers at least one full filter chamber and in many designs will cover several filter chambers. After passing through the filter chambers and the filter media where filtration is complete, the flow goes through the filter support to the disc surface where it contacts and goes through a second footprint in the output body block where the footprint shaped borehole shape is modified within the output body block to a second output flow channel shape and then through the output body block to the output adaptor where the flow rejoins the first flow stream and is directed to downstream processing equipment.

The filter chambers are located on the inlet side of the common rotary disc and since the disc rotates around a hub centered between the two flow paths, as the disc rotates the first and second footprint shapes trace upon the disc an annular zone within which the filter chambers are arrayed, each filter chamber separated from the other filter chambers by a land. The lands are strips of metal integral to the rotary disc that are the same height as and are part of the sealing surface for the metal to metal seal between the input body block and the rotary disc. Each filter chamber extends downward from the surface of the metal to metal seals to form a pocket or chamber that accommodates a multitude of filter media. From the bottom of each filter chamber a plurality of holes are machined through the rotary disc to the output side metal to metal seal area. These holes are ideally tapered 2 to 10 degrees with the larger diameter of approximately 3/32nd inch directed toward the filter chamber.

The filter chambers are shaped in a modified kidney shape which allows pre-filling of the filter chambers with fluid as the filter chambers enter the flow stream and allows improved containment of the fluids trapped in the filter chambers as the filter chambers exit the flow stream due to rotation of the filter chamber containing disc as noted in the Gneuss and the Patrovsky patents cited earlier. The number of filter chambers is ideally an odd number for a rotationally symmetric filter where the flow streams impinge upon the disc 180 degrees from each other around the axis of rotation of the rotary filter disc. If even numbers are used, the modification of the seventh embodiment further improves the flow uniformity.

The parts are attached to each other by bolts with the first adaptor bolted by bolt hole containing flanges into the input body block, the input body block bolted through center spacer blocks and through hub spacer blocks to the output body block (and also bolted from the output body block through center spacer blocks and through hub spacer blocks to the input body blocks) while each rotary filter disc rotates around the hub and is contained by the body blocks.

Metal to metal sealing is enhanced by the balanced bolt patterns such as shown by clearance holes 42 through clearance holes in spacer block 43 and into threaded holes in output body block 32 which accommodate high tensile cap bolts. Similar geometrically balanced bolt clearance holes from output body block 32 through spacer block 43 to threaded holes in input body block 44 provide further fastening forces through further high tensile cap screws. A bolt pattern in the hub area similarly accommodates cap screws from both body blocks through the hub to the opposite body blocks. Tensile tightening forces applied to the cap screws slightly compresses the spacer block and hub to apply a uniform sealing force to seal the body block surfaces to the rotatable discs.

The rotary disc in each case must also be provided with a drive mechanism to rotate it to bring new filter chambers into the footprint areas where they encounter the flow and filter it. To provide ease of filter rotation, the exterior perimeter of the rotary disc has machined gear teeth. These gear teeth engage a further gear external to the disc perimeter and, as this gear turns on its axis powered by air or electrical motors, the teeth on the perimeter of the rotary disc are advanced a small amount rotating the disc.

Typically pressure measurement sensors in the outlet side flows from the filter are set at an absolute or at a differential pressure compared with the inlet side polymer pressure to provide a signal from a controller to actuate the disc rotation as needed.

In this rotary disc filter the polymer flows fluidly communicate through parallel paths with a first path in fluid communication from the first adaptor through first flow borehole in the input body block where the flow shape is modified to the shape of the first inlet footprint, then through the areas bounded by the metal to metal seal between the input side of the first rotary disc and the input body block, then through filter chambers containing filter media in the common rotary disc, through the filter supports of the common rotary disc, and through the areas bounded by the metal to metal seal between the output side of the common rotary disc and the inner surface of the output body block, through the first output flow channel which modifies flow path from the first output side footprint shape to the shape of a flow adaptor and then through the first output flow adaptor to further processing equipment. A parallel path similar to the first path and independent of the first path is in fluid communication from the second inlet adaptor through second flow borehole in the input body block where the flow shape is modified to the shape of the second inlet footprint, then through the areas bounded by the metal to metal seal between the input side of the common rotary disc and the input body block, then through filter chambers containing filter media in the second rotary disc, through the filter supports of the common rotary disc, and through the areas bounded by the metal to metal seal between the output side of the common rotary disc and the output body block, through the second output flow channel which modifies flow path from the second output side footprint shape to the shape of a flow adaptor and then through the second output flow adaptor to further processing equipment.

As will become obvious from examination of FIG. 2, the area available for change of filter media is limited as compared to FIG. 1, an asymmetric rotary filter. The dual flow single disc rotary filter is thus optimal for light contamination problems where the filter media within the rotary disc does not advance due to pressure initiated rotation of the filter disc at a rapid rate. This allows time for filter changing. Due to the limited access, the dual flow filter is also best used where the materials are not hazardous.

In a second embodiment of this invention, a further problem is solved, the dripping that can happen due to flows from the support block holes. In the first embodiment the second or output body block in contact with the filter support and its holes was removed to aid in access to the filter media and to aid when the filter supports are removable. In many cases this extra contact space is not required and the second body block or output body block may be extended to cover all of the annular filter chamber/filter support areas of the disc, essentially covering the entire rear (output side) of the rotary filter disc. Since the disc is in metal to metal seal contact with the output body block, there is no dripping or loss of fluid and the fluid is returned into the flow stream at the temperature of the output body block without exposure to ambient air or loss of fluid.

In a third embodiment, the adaptor blocks which split the flows into dual streams are incorporated into the input and the output body blocks, eliminating a static seal at the expense of complicating the internal flow passage machining of the respective body blocks.

In a fourth embodiment, the concept of multiple flow streams is expanded to a three flow stream rotary disc filter where three individual flow streams are provided, each identical and rotated by 120 degrees around the axis of rotation from each other. It is noted that the three flow channel filter further limits access to the filter media when the filter media must be changed, and thus this embodiment is best for even lower contamination levels.

In a fifth embodiment, an additional flow stream is added to make a total of four flow streams with a rotational displacement form each adjacent flow channel of approximately 90 degrees for every flow channel. Space for service of filter media is extremely limited in this embodiment.

In a sixth embodiment, two flows are maintained as separate flows throughout with either independent fluid sources and/or independent fluid processing equipment after the filtration such that the filter is controlled by the worst pressure differential of the two separate flows to advance the disc travel.

In a seventh embodiment, the device of the first, most preferred embodiment is modified with the location of the two flow passages displaced 180 degrees from each other plus an amount equal to approximately one half of the width of a filter chamber. This modification allows an even number of filter chambers to be located on the rotary filter disc, but further allows the lands separating the filter chambers to enter the flow stream at staggered times which dampens any variations in pressure or flow due to the change if filter flow area due to these lands.

In an eighth embodiment the filter of the first, most preferred embodiment is modified with the axis of rotation of the rotary filter disc offset from the line between the two footprint shapes by an amount that allows the footprints to still trace a common annular zone on said rotary filter disc but less than one sixth of the disc diameter.

In an ninth embodiment the filter media support in the preferred embodiment is replaced and a filter media pack with sufficient rigidity is used without the need for supports, the filter media being held in place by supports added in the output footprint area or by a step within the filter chamber holding the filter media pack.

I claim:

1. A rotating disc filter where fluids in multiple parallel flow channels are filtered within a common rotary filter disc where,
a contaminated fluid enters an entry adaptor where it is split into multiple separate streams within separate flow channels,
each said separate flow stream within a flow channel from said entry adaptor then entering a flow channel within an input body block with an input body block input side attached to said entry adaptor which has an input body block output side and where,
within said input body block, each separate flow stream within each said flow channel is transformed into a footprint shape that expands the area of said flow channel at said output side surface of said input body block, and where there is a rotary filter disc with an input side surface in contact with said output side of said input body block, and with an exit side surface in contact with the input side surface of a output body block, and where each said separate flow within its said flow channel then is directed through at least one filter media within said flow channel removing said contaminants, said filter media located in a filter chamber, at least one said filter channel in each separate flow channel, a plurality said filter chambers which are machined into an annular portion of the rotary filter disc created by said footprint shapes as said rotary filter disc rotates around an axis of rotation such that the footprint shapes locate a common annular area upon said rotary filtration disc as said rotary filtration disc rotates, and where each such filter chamber is separated from adjacent filter chambers by lands on the input surface of said rotary filter disc, and where a metal to metal seal prevents leakage by contact with said output side surface of said input body block and said input side of said common rotary filter disc surface and then said flow is directed through filter support means within said rotary filter disc and where a metal to metal seal is formed between the exit side surface of said common rotary filter disc and said input side surface of said output body block, and then each said flow is directed to a output footprint shape which is machined into an output block within which said output footprint shape of the flow channel on said input surface of said output body block is reduced to a channel shape on said output side surface of said output body block and thence to an adaptor attached to said output body block output surface where each separate flow is joined into a common flow and then to other processing equipment,
each flow channel in fluid communication from said input adaptor through said input body block through said common rotary filter disc and through the filter media within a said filter chamber and through said filter supports for each said filter chamber contained within said rotary filter disc, through said output body block to and through said adaptor where the separate flows are joined, and thence to other processing equipment, and where
a rotation means is provided to rotate said rotary filter disc around its axis of rotation thus moving new filter chambers into said separate flow streams.

2. The rotating disc filter in claim 1 where there are two flow channels, each said flow channel identical except that it is rotated by approximately 180 degrees around the axis of rotation of said common rotary filter disc.

3. The rotating disc filter in claim 2 where the number of said filter chambers within said common annular area is an odd number.

4. The rotating disc filter in claim 1 where there are two flow channels, each said flow channel identical except that it is rotated by approximately 180 degrees plus an amount that allows an additional one half of a filter chamber to enter one flow stream where said footprint shape contacts said rotary disc.

5. The rotating disc filter in claim 4 where the number of said filter chambers within said common annular area is an even number.

6. The rotating disc filter in claim 1 where a three flow channels are provided and each said flow channel is identical except each is rotated to a position approximately 120 degrees around said axis of rotation of said common rotary filter disc from the adjoining flow channel.

7. The rotating disc filter in claim 1 where said output side body block extends to cover essentially all of the output side surface of said common rotary filter disc.

8. The rotating disc filter in claim 2 where said output side body block extends to cover essentially all of the output side surface of said common rotary filter disc.

9. The rotating disc filter in claim 3 where said output side body block extends to cover essentially all of the output side surface of said common rotary filter disc.

10. The rotating disc filter in claim 1 where increased uniformity of temperature adapts use to polymers which have a narrow plastic transition range and said uniformity of temperature prevents freezing of said polymers.

11. A dual flow common disc rotary filter where two fluid flows are separately filtered, where a first fluid flow is directed from first fluid source into a first input flow channel, said first input flow channel and its included first flow stream is then directed into and contained within a first flow channel in a first body block, and where said first flow stream within said first flow channel is directed through said first body block which has an outside surface in contact with said adaptor and an inside surface in contact with a common rotary filter disc, and where said first flow stream is shaped to a first inlet footprint shape by said first flow channel where the first inlet footprint shape is an enlarged flow channel area located on the inside surface of said first body block, and where
said second input fluid flow is directed into a second input flow channel, said second input flow channel and its included second flow stream is then directed into and contained within a second flow channel in said first body block, and where said second flow stream within said second flow channel is directed through said first body block which has said outside surface in contact with said adaptor and said inside surface in contact with a portion of said common rotary filter disc, and where said second flow stream is shaped to a second inlet footprint shape by said second flow channel where said second inlet footprint shape is an enlarged flow channel area located on the inside surface of said first body block, and where said common rotary filter disc with an inside surface and an outside surface is rotatabily mounted on a hub located such that the rotation of said common rotary filter disc around its axis of rotation causes said first inlet footprint and said second inlet footprint shape to trace a common annular area on said disc, and where said common rotary filter disc is provided with a series of shaped filter chambers in said disc in said annular area of said disc, each filter chamber consisting of a land separating it from the next chamber and the filter chamber further consisting of a filter media support that provides fluid communication passages between said inside surface and said outside surface of said disc, and a space inset into said inside surface which may contain a filter media and where a portion of said annular area on said common rotary filter disc inside surface is in contact with said inside surface of said first body block and with said first inlet footprint, and where said outside surface of said common rotary filter disc is in contact with an inside surface of a second body block which has a first discharge side footprint in contact with said annular area demarked by the first fluid communication passages, and where said first discharge side footprint area is the start of a first exit fluid channel, and where said first exit fluid channel is in fluid communication with a first exit channel, and where said a first flow channel, said first flow channel and its included first flow stream is then directed into and contained within a flow channel through a first body block, and where said first body block and said second body block are separated by spacer blocks and hubs, and where said first body block, said spacers and hubs, and said second body block are fastened by fastening means, and where said fastening means provides toque and compression to provide for both rotary motion of said disc and provide sealing between said first body block and said disc inside and between said second body block and said outside surface of said disc, and where each said fluid containing flow stream communicates from said first body block through said filter chambers in said disc to said second body block, and where said common rotatable filter disc is rotated by rotating means to move new filter chambers into said first and second flow streams.

12. The claim in 11 where a single infeed flow enters an infeed adaptor where said infeed flow is split into a first fluid flow and a second fluid flow, and where said first fluid flow in said infeed adaptor is directed into a first flow channel in said first body block and said second fluid flow is directed into a second flow channel in said first body block.

13. The claim in 11 where an exit adaptor is attached to said second body block output surface by attaching means and where said first fluid flow from said second body block and said second fluid flow from said second body block are directed into a common flow channel.

14. The claim in 11 where said second body block is extended to cover essentially all of said output surface of said rotary disc.

15. A rotary disc filter for filtering contaminated fluid where a first body block which has a outer surface and an inside surface and a second body block which has an outer and an inner surface and spacers form a slot, and where said slot is defined by said inner surface of said first body block and said inside surface of said second body block and separated by spacer blocks between said first body block and said second body block surrounding a portion of a central spherical zone of a rotary disc partially contained within said slot, and where fastening means through said first body block, through said spacer block to said second body block and from said second body block, through said spacer blocks to said first body block provides a slot width and where said hub which is mounted centrally in said slot and which is the center of rotation of said rotary disc within said slot where said hub fastening means from said first body block, through said hub and into said second body block and from said second body block through said hub to said first body block jointly provide slot width control for said disc in said slot and where said rotary disc has an input surface in rotary contact with said inner input body block surface and an output surface in rotary contact with said inner surface of said output body block, and where said rotary disc contains a plurality of filter chambers, each separated from adjacent filter chambers by a land on the input surface of said rotary disc and which are located in an annular area of said disc, and where said filter chambers hold filter media and have a filter support consisting of through holes in said rotary disc which terminates on said output surface of said rotary disc, and where a first fluid flow channel communicates from the outside surface of said first block through said first body block to at least one of said filter chambers located in an annular area traced by said first flow channel on said common rotary disc which contains a further flow channel provided with an area for holding filter media and a support for said filter media, all which are in fluid communication with said second body block and through a flow channel in said second body block to the outside surface of said second body block, and where a second fluid flow channel communicates from the outside surface of said first block through said first block to said annular area traced by said first flow channel located on said common rotary disc which contains a further flow channel provided with an area for holding filter media and a support for said filter media which is in fluid communication with said second body block and through a flow channel in said second body block to the outside surface of said second body block, and where rotary sealing means provide metal to metal seals between first body block and said input surface of said rotary disc and between said output surface of said inside surface of said second body block, and where rotating means rotate said rotatable filter disc to bring new filter chambers containing uncontaminated filter media into each said flow stream, removing contaminated filter media in chambers removed from said flow streams.

16. The rotary disc filtration unit in claim 15 where a diverter is further provided as a separate adaptor block to split a single flow stream between said first flow channel location and said second flow channel location.

17. The rotary disc filtration unit in claim 15 where separate flow combining adaptor is further provided attached by attaching means to said second body block to combine the flow stream from said first flow stream location and said second flow stream location into single flow stream within said flow combining exit adaptor block into a single exit flow channel.

18. The rotary filter in claim 15 where said first body block is extended to cover all of said annular area of said rotary filter disc inlet surface.

19. A method of expanding flow capacity of a rotary disc filter where a array of two or more separate flow passages with separate flows through a common rotatable disc, sealed by rotatable metal to metal entry seals to an infeed block which delivers a flow of externally supplied fluids to each of said separate flows, each separate flow then supplied to one or more filter chambers rotationally displaced from the filter chambers contacting the other said flow, from a plurality of filter chambers located in an annular area of said common disc and separated from adjacent filter chambers by lands, said common rotatable disc filter chambers located in a zone of said common rotatable disc defined by the contact between each of said separate flow passages and said common disc as said disc rotates around an axis of rotation, each said filter chamber containing filter media and filter supports, and where flow through filter media within said filter chamber filters said separate flows, and then, after exit from said common disc, said flow, sealed by rotatable metal to metal exit seals to an output block, is directed within an output block through flow passages in said output block and then to other processing equipment, and where sensing and control means detects increase in pressure of said flows due to contamination of said filter media, and by rotating means rotates said common rotatable disc to rotate new filter chambers containing uncontaminated filter media into said flow streams and remove filter chambers containing contaminated filter media from said flow streams.
